(19) United States
(12) Patent Application Publication
(10) Pub. No.: US 2026/0360059 A1
(43) Pub. Date: Nov. 12, 2026

(54) MUSIC-DRIVEN VIDEO GENERATION

(71) Applicant: Bytedance Technology Ltd., Grand Cayman (KY)

(72) Inventors: Zhikang Dong, CULVER CITY, CA (US); Peng Zhang, Los Angeles, CA (US); Ju-Chiang Wang, Los Angeles, CA (US); Jitong Chen, Los Angeles, CA (US); Yuxuan Wang, Los Angeles, CA (US)

(21) Appl. No.: 19/201,356

(22) Filed: May 7, 2025

(51) Int. Cl. G06T 13/20; G06T 5/70; G06T 7/11; G06T 7/194; G10H 1/00; G11B 27/10

(52) U.S. Cl. CPC G06T 13/205; G06T 5/70; G06T 7/11; G06T 7/194; G10H 1/0008; G11B 27/10; G10H 2210/076

(57) ABSTRACT

Embodiments of the disclosure provide a solution for video generation. A method includes: obtaining a reference image comprising an object, a music audio, and a text prompt describing a motion to be performed by the object; determining beat information based on the music audio; and generating, using a trained video generation model, a video based on the reference image, the music audio, the text prompt, and the beat information, wherein the video contains a motion sequence of the object that aligns with beats in the music audio.

### FIELD

The present disclosure generally relates to computer technologies, and more specifically, to a method, apparatus, device and computer readable storage medium for video generation.

### BACKGROUND

Recently, artificial intelligence (AI) has made significant strides across various domains. In particular, image animation has advanced through the use of guidance, such as motion, text and the like. Static images may be animated by applying motion to main characters within them. However, the task of music-guided image animation remains relatively under-explored. This task involves animating characters to dance in synchronization with music, ensuring the video aligns with the musical theme and follows the beats.

### SUMMARY

In a first aspect of the present disclosure, there is provided a method of video generation. The method comprises: obtaining a reference image comprising an object, a music audio, and a text prompt describing a motion to be performed by the object; determining beat information based on the music audio; and generating, using a trained video generation model, a video based on the reference image, the music audio, the text prompt, and the beat information, wherein the video contains a motion sequence of the object that aligns with beats in the music audio.

In a second aspect of the present disclosure, there is provided an apparatus for video generation. The apparatus comprises: an obtaining module configured to obtain a reference image comprising an object, a music audio, and a text prompt describing a motion to be performed by the object; a determining module configured to determine beat information based on the music audio; and a generating module configured to generate, using a trained video generation model, a video based on the reference image, the music audio, the text prompt, and the beat information, wherein the video contains a motion sequence of the object that aligns with beats in the music audio.

In a third aspect of the present disclosure, there is provided an electronic device. The electronic device comprises: at least one processor; and at least one memory coupled to the at least one processor and storing instructions executable by the at least one processor, the instructions, upon execution by the at least one processor, causing the electronic device to perform: obtaining a reference image comprising an object, a music audio, and a text prompt describing a motion to be performed by the object; determining beat information based on the music audio; and generating, using a trained video generation model, a video based on the reference image, the music audio, the text prompt, and the beat information, wherein the video contains a motion sequence of the object that aligns with beats in the music audio.

In a fourth aspect of the present disclosure, a computer-readable storage medium is provided. The computer-readable storage medium stores computer executable instructions which, when executed by an electronic device, causes the electronic device perform operations comprising: obtaining a reference image comprising an object, a music audio, and a text prompt describing a motion to be performed by the object; determining beat information based on the music audio; and generating, using a trained video generation model, a video based on the reference image, the music audio, the text prompt, and the beat information, wherein the video contains a motion sequence of the object that aligns with beats in the music audio.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2A illustrates a schematic diagram of an inference process of the video generation model in accordance with some embodiments of the present disclosure;

FIG. 2B illustrates a schematic diagram of a training process of the video generation model in accordance with some embodiments of the present disclosure;

FIG. 3 illustrates a flowchart of a process for video generation in accordance with some embodiments of the present disclosure;

FIG. 4 shows a block diagram of an apparatus for video generation in accordance with some embodiments of the present disclosure; and

FIG. 5 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

As used herein, the term “model” can learn a correlation between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. A neural networks model is an example of a deep learning-based model. As used herein, “model” may also be referred to as “machine learning model”, “learning model”, “machine learning network”, or “learning network”, and these terms are used interchangeably herein.

“Neural networks” are a type of machine learning network based on deep learning. Neural networks are capable of processing inputs and providing corresponding outputs, typically comprising input and output layers and one or more hidden layers between the input and output layers. Neural networks used in deep learning applications typically comprise many hidden layers, thereby increasing the depth of the network. The layers of neural networks are sequentially connected so that the output of the previous layer is provided as input to the latter layer, where the input layer receives the input of the neural network and the output of the output layer serves as the final output of the neural network. Each layer of a neural network comprises one or more nodes (also known as processing nodes or neurons), each of which processes input from the previous layer.

Usually, machine learning can roughly comprise three stages, namely training stage, test stage, and application stage (also known as inference stage). During the training stage, a given model can be trained using a large scale of training data, iteratively updating parameter values until the model can obtain consistent inference from the training data that meets the expected objective. Through the training, the model can be considered to learn the correlation between input and output (also known as input-to-output mapping) from the training data. The parameter values of the trained model are determined. In the test stage, test inputs are applied to the trained model to test whether the model can provide correct outputs, thereby determining the performance of the model. In the application stage, the model can be used to process actual inputs and determine corresponding outputs based on the parameter values obtained from training.

A diffusion model, also known as a diffusion probability model, is a type of generative model. This model generates data by simulating the diffusion process. This process is inspired by physical processes such as thermal diffusion. The diffusion model includes forward diffusion process and reverse diffusion process. The diffusion model simulates a forward diffusion process that gradually adds noise, and then learns how to reverse this process to generate new data samples.

In the forward diffusion process, noise is gradually added to the data, and through a series of steps, the data becomes increasingly random until it resembles pure noise. This process can be seen as a Markov chain, where Gaussian noise is added to the data at each step. The forward diffusion process can be expressed as: q(xₜ|xₜ₋₁)= [symbol] (xₜ \sqrt{αₜ}xₜ₋₁, (1−αₜ)I), where xₜ is the noise data from step t, αₜ is used to control the amount of added noise. The forward diffusion process is performed during model training, and the data used to add noise is the training sample.

In the reverse diffusion process (or reverse denoising process), the model learns how to reverse the step of adding noise. Starting from pure noise, the diffusion model gradually removes the noise and generates data that matches the training distribution. The reverse diffusion process is typically simulated using a neural network that predicts the noise added at each step: p_{θ}(xₜ₋₁|xₜ)= [symbol] (xₜ₋₁; μ_{θ}(xₜ, t), σ_{θ}(xₜ, t), where μ_{θ} and σ_{θ} represent learned model parameters. After completing the model training, the model that performs the backpropagation process can first sample from the noise distribution and iteratively denoise using until the desired data is obtained.

In the diffusion model, time step refers to the number of steps in which noise is added during the forward diffusion process. The total number of steps T is usually a predetermined value, indicating how many steps are required for the transition from raw data to pure noise. At each time step t, Gaussian noise is added to the data according to a predetermined noise scheme, which is continuous and dependent on the results of the previous step.

When generating data, the inference step of the diffusion model refers to the number of steps required to recover the original data from pure noise during the backward diffusion process. The number of reasoning steps directly affects the quality and speed of generating data. The more reasoning steps there are, the higher the quality of the generated data, but at the same time, it also increases computational costs and time. In practical applications, the balance between generation quality and efficiency can be achieved by adjusting the number of inference steps. In some embodiments, the inference steps correspond to time steps, and each inference step may correspond to one or more time steps. For example, if the total time steps of the diffusion model are 1000 steps and the inference steps are set to 50 steps, then each inference step may be considered as corresponding to 20 time steps.

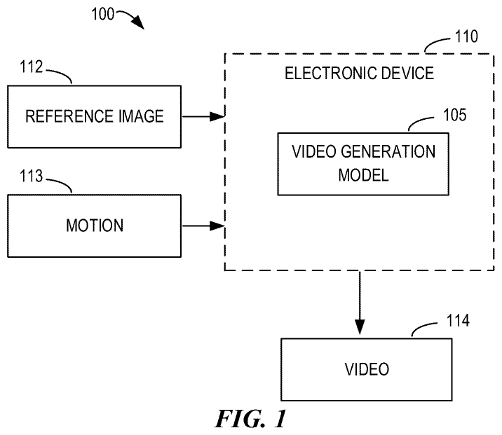

FIG. 1 illustrates a block diagram of an example environment 100 in which various embodiments of the present disclosure may be implemented. In the environment 100 of FIG. 1, an electronic device 110 applies a video generation model 105 to perform video generation. The video generation model 105 is configured to generate a video 114 based on a reference image 112 and a motion 113, and the video 114 contains a sequence of frames of an object in the reference image 112 performing the motion 113.

The video generation model 105 may be configured as any suitable type of models that is capable of generating a video. In some embodiments, the video generation model 105 may be constructed based on a type of generative model. In an example, the video generation model 105 may be constructed based on a diffusion model.

In FIG. 1, the electronic device 110 may be implemented at any computing system with computing capability, such as various computing devices/systems, terminal devices, servers, etc. Terminal devices may include any type of mobile terminals, fixed terminals, or portable terminals, including mobile phones, desktop computers, laptops, netbooks, tablets, media computers, multimedia tablets, or any combination of the aforementioned, including accessories and peripherals of these devices or any combination thereof. Servers include but are not limited to mainframe, edge computing nodes, computing devices in cloud environment, etc.

It should be understood that the structure and function of each element in the environment 100 is described for illustrative purposes only and does not imply any limitations on the scope of the present disclosure.

Video generation is an important task in artificial intelligence generated content (AIGC). Methods like variational recurrent neural network (RNNs) and generative adversarial networks (GANs) have been explored to perform the task. However, most of those works are limited to low-resolution, the lack of large scale high-quality datasets or loose control ability. Diffusion models are proposed to solve this problem.

Music-guided dance generation in three-dimensional (3D) sequences has been explored in recent works. In an example, a related work integrates lyrics information to enable the generation of more diverse 3D dance sequences. 3D dance sequence generation models produce only skeleton key points, rather than full dance videos, limiting their practical application. Music-guided dance generation in two dimensional (2D) videos is still unexplored. In an example, a related work utilizes a diffusion model to generate optical flow, which is then combined with a reference image for animation. However, their approach operates at low resolution and has not been tested on specific, large-scale datasets, leading to lower diversity in 2D dance video generation.

Some works on human body motion transfer demonstrate lower accuracy and require significant human intervention. Recently, deep learning techniques have enabled more realistic motion transfer with highly automated training pipelines. In human dance transfer domain, a work generates human dance videos from dance skeleton sequences and a reference human image. Another work incorporates facial key points with body skeletons as guidance to generate realistic human dance videos. However, these approaches still require pose guidance (e.g., a skeleton) to generate dance videos, and such pose guidance is not always available, limiting the generalization capability of these models.

As can be seen from above, several challenges in music-guided image animation, particularly in dance video generation, remain unresolved. A challenge is the scarcity of large-scale datasets containing dance videos with a variety of subjects (not limited to human dancers) synchronized with background music and accompanied by corresponding text captions. Another challenge is the lack of flexible control over the video generation process. A further challenge is the limited generalization beyond the scope of the training dataset. Current motion transfer models rely on motion guidance inputs such as pose, video, depth, and skeleton-based sequences to animate reference images. However, these models often fail to meet user preferences and the availability of such guidance is limited. In addition, existing dance motion transfer models focus predominantly on human motion, as the guidance is generally designed for human figures, thereby restricting creativity.

Embodiments of the present disclosure propose an improved solution for video generation. In this solution, a reference image comprising an object, a music audio, and a text prompt describing a motion to be performed by the object are obtained. Beat information is determined on the music audio. Then, a trained video generation model is used to generate a video based on the reference image, the music audio, the text prompt, and the beat information, wherein the video contains a motion sequence of the object that aligns with beats in the music audio.

With these embodiments of the present disclosure, the music audio, the beat information and the text prompt may be used as driving factors or conditions to animate the reference image in a way that aligns with the semantic of the input information. In this way, the object in the reference image may be animated to dance rhythmically to the music with specified motions. It enables the robust generalization and the robust generalization of the video generation.

In order to better illustrate embodiments of the present disclosure, concepts about diffusion models may be introduced first. Latent diffusion models denote a class of diffusion models that operate within the encoded latent space produced by an autoencoder, represented as [symbol] (ε(·)). One of the most widely used models in this category is Stable Diffusion, which incorporates a vector quantized variational autoencoder (VQ-VAE) and a time-conditioned convolutional neural network (CNN) architecture. Additionally, Stable Diffusion utilizes a text encoder to encode text prompts into embeddings. Given an image I ∈ [symbol] ^{H}^{_{I}}^{×W}^{_{I}}^{×3} and its corresponding text embedding Cₜₑₓₜ ∈ [symbol] ^{D}^{_{c}}, a latent representation z₀=ε(I) ∈ [symbol] ^{H}^{_{z}}^{×W}^{_{z}}^{×D}^{_{z}} may be obtained and applied to a predefined diffusion process across T timesteps, modeled as a Gaussian process. This process approximates a standard Gaussian distribution, z_{T}~ [symbol] (0, I). The training objective in Stable Diffusion is to iteratively denoise z_{T} back to the original latent representation z₀.

During inference, the original latent zₜ is reconstructed using sampling methods, such as denoising diffusion implicit models. Then, the latent zₜ is decoded by a decoder D to generate a final, clear image. Latent diffusion models may produce high-fidelity images and align the generated images with the text-conditioned prompt.

Cross attention mechanism is a key component in the model structure of latent diffusion models. This mechanism integrates information from the latent representation and the conditional embedding, enabling latent diffusion models to generate images that semantically align with the given condition. More generally, the conditioning modality may include text, motion flows, audio and the like, which provides semantic guidance for the generation process.

A neural network model is designed to control the generation process without modifying the pretrained diffusion model. This neural network model duplicates the original parameters into a trainable copy while freezing the original weights, allowing the model to retain its generalization ability from large-scale image datasets while fine-tuning the trainable copy for the specific task. The two copies of the model are connected through zero convolution layers, which progressively integrate the information flow. This neural network model enables precise control over image generation by conditioning diffusion models on additional inputs such as edges, poses, or segmentation maps, allowing for more targeted and customizable outputs while maintaining high image quality.

Example embodiments of the present disclosure will be described with reference to the drawings.

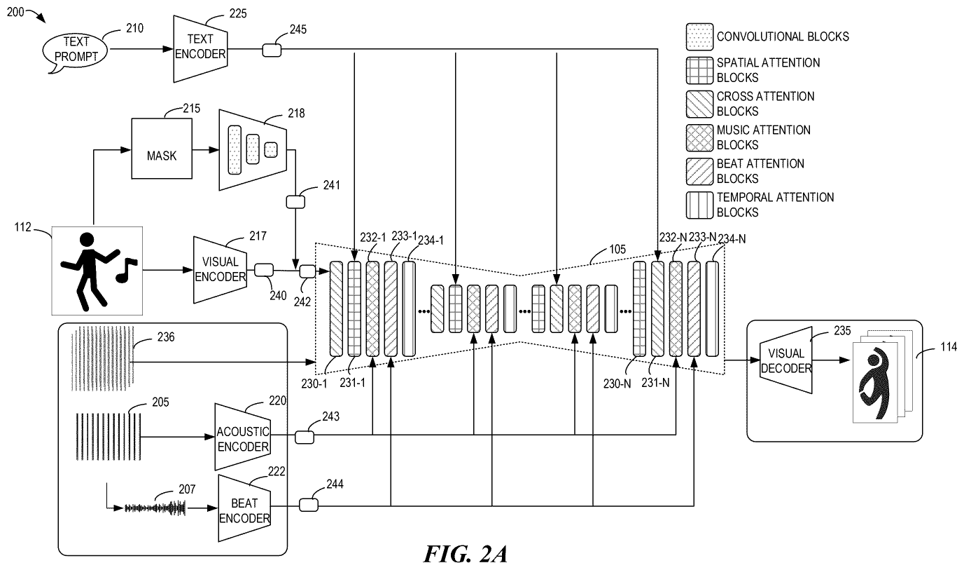

FIG. 2A illustrates a schematic diagram of an inference process 200 of the video generation model 105 in accordance with some embodiments of the present disclosure. As shown in FIG. 2A, in order to generate the video 114, a reference image 112 comprising an object is obtained. In some examples, the object may include a human, a cartoon character, an animal and the like. In addition, a music audio 205 and a text prompt 210 describing a motion to be performed by the object are also obtained to generate the video 114. In an example, the text prompt 210 may be “raising and lowering arms” and the object in the generated video 114 may perform the motion (e.g., raising and lowering arms) described by the text prompt 210. It should be appreciated that the reference image 112, the music audio 205 and the text prompt 210 may be any images, music and text input or indicated by a user.

After obtaining the music audio 205, beat information 207 is determined based on the music audio 205. It is observed that in most music audios (e.g., music audios extracted from dance videos), the music beat serves as a strong signal, often marking the start, stop, or change in dance style. Therefore, beat information 207 may be determined to capture this pattern.

In some embodiments, a plurality of beats may be identified from a plurality of audio frames of the music audio 205. Then, the beat information 207 may be determined based on the plurality of beats. The beat information 207 may indicate that a plurality of audio frames with the plurality beats in the music audio 205 are assigned a first value and audio frames other than the plurality of audio frames are assigned a second value. In some examples, locations of the plurality of beats in the music audio 205 may be identified and converted into a one-hot encoded format. This produces a binary vector b_{binary} ∈ [symbol] ^{K}, where audio frames with a beat are assigned a value of 1 (as an example of the first value), and other audio frames are assigned a value of 0 (as an example of the second value). It is to be noted that determining beat information 207 based on identifying beats is merely an example and it may be implemented by any other suitable ways.

Then, a trained video generation model 105 is used to generate the video 114 based on the reference image 112, the music audio 205, the text prompt 210 and the beat information 207. The video 114 contains a motion sequence of the object that aligns with beats in the music audio 205.

In some embodiments, a plurality of masks 215 (denoted as Dᵢ) for masking a plurality of segments in the reference image 112 may be obtained respectively. The plurality of segments may comprise a background of the reference image 112, and a plurality of parts of the object. In some examples, the plurality of parts of the object may include a head, arms, a body and the like of the object. Then, the video 114 may be generated further based on the plurality of masks 215. In this way, a dense and robust pose signal of the object in the reference image 112 may be obtained and the video generation model 105 may focus on different parts in the reference image 112.

The video 114 may be generated further based on feature representations related to the reference image 112. In some embodiments, a first visual feature representation 240 of the reference image 112 may be extracted. The first visual feature representation 240 may characterize an appearance of the object. In some examples, the reference image 112 may be input to a visual encoder 217 to generate the first visual feature representation 240. The visual encoder 217 may extract semantic information (e.g., the first visual feature representation 240) in the high dimensional latent space a raw input (e.g., the reference image 112). In an example, the visual encoder 217 may include a VAE encoder. In some other examples, the visual encoder 217 may be constructed based on CNNs, vision transformers (ViTs) or any other suitable model structure.

A second visual feature representation 241 of the plurality of masks 215 may be extracted. The second visual feature representation 241 may characterize a pose of the object. In some examples, the plurality of masks 215 may be input to a mask encoder 218 including a series of convolutional blocks, to progressively downsample and extract the second visual feature representation 241 (also referred to as mask features).

After extracting these visual feature representations, the first visual feature representation 240 and the second visual feature representation 241 may be combined to obtain a combined visual feature representation 242. In some examples, the second visual feature representation 241 may be incorporated into the first visual feature representation 240 in a residual manner, which is shown as follows:

z₀=ε(Iᵢ)+Conv(Dᵢ) (1)
where ε(Iᵢ) represents the first visual feature representation 240, Conv(Dᵢ) represents the second visual feature representation 241 and z₀ represents the combined visual feature representation 242. Then, the video 114 may be generated based on the combined visual feature representation 242, the music audio 205, the text prompt 210, and the beat information 207.

The video 114 may be generated further based on feature representations related to the music audio 205. In some embodiments, an acoustic feature representation 243 (also referred to as music embedding) of the music audio 205 may be extracted. The acoustic feature representation 243 may characterize semantics of the music audio 205. In some examples, the music audio 205 may be input to an acoustic encoder 220 to generate the acoustic feature representation 243. The acoustic encoder 220 may capture the essence (e.g., melody, rhythm, and timbre) of the music audio 205, to generate the acoustic feature representation 243. In an example, the acoustic encoder 220 may include an audio spectrogram transformer (AST) encoder. In some other examples, the acoustic encoder 220 may also include some other Transformer-based encoders, CNN-based encoders or any other suitable model structure.

A beat feature representation 244 of the beat information 207 may be extracted. The beat feature representation 244 may characterize beats of the music audio 205. In some examples, the beat information 207 may be input to a beat encoder 222 to generate the beat feature representation 244 (denoted as b_{dense} ∈ [symbol] ^{K×d}). The beat encoder 222 may include a lookup embedding layer, which is configured to transform a discrete embedding (e.g., the beat information 207) into a continuous dense embedding (e.g., the beat feature representation 244). Then, the video 114 may be generated based on the reference image 112, the acoustic feature representation 243, the text prompt 210 and the beat feature representation 244.

In some embodiments, a text feature representation 245 of the text prompt 210 may be extracted. In some examples, the text prompt 210 may be input to a text encoder 225 to generate the text feature representation 245 (also referred to as word embeddings). In an example, the text encoder 225 may be constructed based on a contrastive language-image pre-training (CLIP) model. In some examples, the text encoder 225 may be constructed based on CNNs, Transformers, recurrent neural networks (RNNs) or any other suitable model structure. From the perspective of feature representations, the video 114 may be generated based on the combined visual feature representation 242, the acoustic feature representation 243, the text feature representation 245 and the beat feature representation 244. In this way, customization may be enhanced by incorporating the text prompt 210. Even with the same appearance and background, users can express different dance motions guided by the music audio 205, creating personalized content that enhances user engagement and amplifies the reach of the music audio 205. This allows users to frequently create videos choreographed to popular music.

In some embodiments, respective attention mechanisms may be applied to a combined visual feature representation 242 of the reference image 112, an acoustic feature representation 243 of the music audio 205, a text feature representation 245 of the text prompt 210 and a beat feature representation 244 of the beat information 207, to obtain a video feature representation. In some examples, the video generation model 105 may include a plurality of spatial attention blocks 230-1 to 230-N (referred to as spatial attention block 230 individually or collectively), a plurality of cross-attention blocks 231-1 to 231-N (referred to as cross-attention block 231 individually or collectively), a plurality of music attention blocks 232-1 to 232-N (referred to as music attention block 232 individually or collectively), a plurality of beat attention blocks 233-1 to 233-N (referred to as beat attention block 233 individually or collectively) and a plurality of temporal attention blocks 234-1 to 234-N (referred to as temporal attention block 234 individually or collectively).

In some embodiments, a self-attention mechanism may be applied to the combined visual feature representation 242, e.g., at the spatial attention block 230, to obtain an updated visual feature representation (not shown). In some examples, for each element of the combined visual feature representation 242, the self-attention mechanism may calculate a set of attention scores that represent the relevance or importance of every other element to the current element and these attention scores are then used to compute a weighted sum of the elements, which is used to generate the updated visual feature representation. In this way, dependencies between elements of the combined visual feature representation 242 may be effectively captured.

A cross-attention mechanism may be applied to the updated visual feature representation and the text feature representation 245, e.g., at the cross attention block 231, to obtain a first fused feature representation (not shown). In some examples, the first fused feature representation may capture visual information of the reference image 112. The cross-attention mechanism helps the video generation model 105 to align and integrate information between different information sources (e.g., the updated visual feature representation and the text feature representation 245).

A cross-attention mechanism may be applied to the first fused feature representation and the acoustic feature representation 243, e.g., at the music attention block 232, to obtain a second fused feature representation (not shown). In some examples, given the hidden states (e.g., the first fused feature representation) from the previous module (e.g., the cross attention block 231), zₜ ∈ [symbol] ^{K×(H}^{_{z}}^{W}^{_{z}}^{)×d}, where K represents the number of generated video frames and the acoustic feature representation 243 C_{music} ∈ [symbol] ^{L×d}, where L represents the sequence length of the acoustic feature representation 243, the cross-attention mechanism may be applied between the acoustic feature representation 243 and the first fused feature representation to facilitate information flow across these two modalities (i.e., music and video), allowing the music dynamics to control video frame generation. In some examples, to further improve temporal alignment, the first fused feature representation may be reshaped into zₜ ∈ [symbol] ^{(H}^{_{z}}^{W}^{_{z}}^{)×k×d} and self-attention along the temporal dimension may be computed. In this way, semantic alignment of music features with video frames may be achieved.

A cross-attention mechanism may be applied to the second fused feature representation and the beat feature representation 244, e.g., at the beat attention block 233, to obtain a third fused feature representation (not shown). The cross-attention mechanism may help the hidden states (e.g., the second fused feature representation) learn the beat information. In some examples, the hidden states may also be reshaped and temporal attention layers may be applied to ensure temporal continuity. In this way, temporal alignment with beats may be achieved.

In addition, a self-attention mechanism may be applied to the third fused feature representation, e.g., at the temporal attention block 234, to obtain the video feature representation (not shown). In some examples, several previously generated video frames may be used as guidance. There video frames may be concatenated with the current hidden states (e.g., the third fused feature representation) and the self-attention mechanism may be performed across the temporal sequence dimension. Specifically, a concatenated hidden state

$${z}_{motion} = concat ( {z}_{t}^{′} , {z}_{t} )$$

may be formed, where

$${z}_{t}^{′} ∈ {ℝ}^{( {H}_{z} {W}_{z} ) \times M \times d}$$

represents the hidden states from the previous M generated frames. By applying the self-attention mechanism on zₘₒₜᵢₒₙ across the temporal axis, the last K hidden states may be selected as the current generated video frames. In this way, consistency across video frames may be achieved, thereby resulting in engaging and dynamic animations.

Then, the video 114 may be generated by decoding the video feature representation. In some examples, the video feature representation may be input to the visual decoder 235 to generate the video 114. It is to be noted that any suitable decoders may be used to decode the video feature representation, to generate the video 114.

In some embodiments, the video generation model 105 may be constructed based on a diffusion model. A denoising operation may be performed iteratively on a sequence of noise images 236 based on the reference image 112, the music audio 205, the text prompt 210, and the beat information 207, to obtain a sequence of denoised images. In some examples, the reference image 112, the music audio 205, the text prompt 210, and the beat information 207 may be used as conditions to guide the video generation model 105 to perform the denoising operation. Then, the video 114 may be generated based on the sequence of denoised images.

The following will describe a training process of the video generation model 105 with reference to FIG. 2B, which illustrates a schematic diagram of a training process 250 of the video generation model 105 in accordance with some embodiments of the present disclosure. As shown in FIG. 2B, the video generation model 105 may be constructed to include a reference network 252 and a denoising network 253. The reference network 252 may be a U-Net-based stable diffusion model with the same layers as a backbone diffusion model and the reference network 252 may be used to extract visual information from the reference image, denoted as R.

In some embodiments, the reference network 252 may include a plurality of spatial attention blocks 253-1 to 253-N (referred to as spatial attention block 253 collectively or individually) and a plurality of cross-attention blocks 254-1 to 254-N (referred to as cross-attention block 254 collectively or individually). In order to train the spatial attention block 253 and the cross-attention block 254, a sample reference image 255 and a target image (not shown) may be selected from a sample video. The sample video may comprise a sample object performing a sample motion. In some examples, one frame in the sample video may be randomly selected as the sample reference image 255 and another frame within a fixed time window may be selected as the target image. Given the sample video with N frames, denoted as V=I₁, . . . , I_{N}, a frame Iᵢ may be randomly sampled as the sample reference image 255, where i ∈ (w, N−w), with w representing the fixed time window. Then, a frame Iⱼ may be randomly selected as the target image, where j ∈ (i−w, i+w) and j≠i. In some examples, the target image may be preceding to or subsequent to sample reference image 255.

Then, a sample text 257 describing the sample motion may be obtained. In some embodiments, the sample text 257 may be generated, using a language model, based on the sample video. In some examples, the sample video may be sampled every 10 frames. These sampled frames and a prompt may be input to the language model, to generate the sample text 257. For example, the prompt provided to the language model may be “Please describe the movements in each video. Follow these guidelines: 1. Focus specifically on the motion and actions of the dancer. 2. Avoid describing the dancer's appearance or the background . . . ”.

Then, a predicted image 256 may be generated, at least using the spatial attention block 253 and the cross-attention block 254, based on the sample reference image 255 and the sample text 257. In some examples, a feature representation output by the cross-attention block 254 may be transmitted to the denoising network 253 and the denoising network 253 may perform a denoising operating iteratively on a noise 261 condition on feature representation. Then, a visual decoder 260 may be used to decode the output of the denoising network 253, to generate the predicted image 256.

In some examples, a plurality of sample masks 258 for masking a plurality of segments in the sample reference image 255. The predicted image 256 may further be generated based on the plurality of sample masks 258. Details of extracting features representations of the sample reference image 255, the sample text 257 and the plurality of sample masks 258 may refer to the process 200, which are not repeated here.

The spatial attention block 253 and the cross-attention block 254 may be updated based on a difference between the predicted image 256 and the target image. In some examples, the spatial attention block 253 and the cross-attention block 254 may be updated based on a training objective, which is configured to minimize or reduce the difference. In this way, the video generation model 105 may learn single-frame generation by focusing on the appearance of the sample reference image 255, and disentangles appearance and motion using sample text 257.

Compared with the reference network 252, the denoising network 253 may further include the music attention block 232, the beat attention block 233 and the temporal attention block 234. After updating the spatial attention block 253 and the cross-attention block 254, weights of the spatial attention block 253 and the cross-attention block 254 may be shared with the spatial attention block 230 and the cross-attention block 231 of the denoising network 253.

In some embodiments, a predicted video 261 may be generated, using the video generation model 105 (e.g., the denoising network 253), based on a first image (not shown) of the sample video, the sample text 257, and a sample music audio 262 corresponding to the sample video. In some examples, sample beat information 263 of the sample music audio 262 may also be used to generate the predicted video 261. Details of extracting features representations of the first image, the sample text 257 and the sample music audio 262 may refer to the process 200, which is not repeated here.

Then, the music attention block 232, the beat attention block 233 and the temporal attention block 234 may be updated based on a difference between the predicted video 261 and the sample video while the spatial attention block 230 and the cross-attention block 231 may be maintained unchanged. In some examples, the music attention block 232, the beat attention block 233 and the temporal attention block 234 may be trained based on a training objective, which is configured to minimize or reduce the difference. After the training process 250 is completed, the denoising network 253 may be used for inference. In this way, the video generation model 105 may learn to create video sequences using the sample music audio 262, sample beat information 263, and motion guidance (e.g., the sample text 257), with the spatial attention block 230 and the cross-attention block 231 frozen to preserve the appearance quality.

In some examples, suppose features from the denoising network 253 are denoted as x_{d} ∈ [symbol] ^{H}^{_{z}}^{×W}^{_{z}}^{×d} and features from the reference network 252 are denoted as z_{R} ∈ [symbol] ^{H}^{_{z}}^{×W}^{_{z}}^{×d}. Firstly, these two features may be concatenated along the W dimension and this concatenated feature may be passed through spatial self-attention layers, extracting the first half as the output. Then, this output may be applied to cross-attention layers to learn the semantic meaning provided by the text encoder 225, denoted as CrossAttn (zₜ, Cₜₑₓₜ). This approach enables the video generation model 105 to learn pose and appearance in the selected frames with high-level semantics. Since the reference network 252 has a structure similar to that of the denoising network 253, it can generate feature maps that integrate into the denoising network 253, enhancing the quality of generated frames with detailed visual information of both foreground and background.

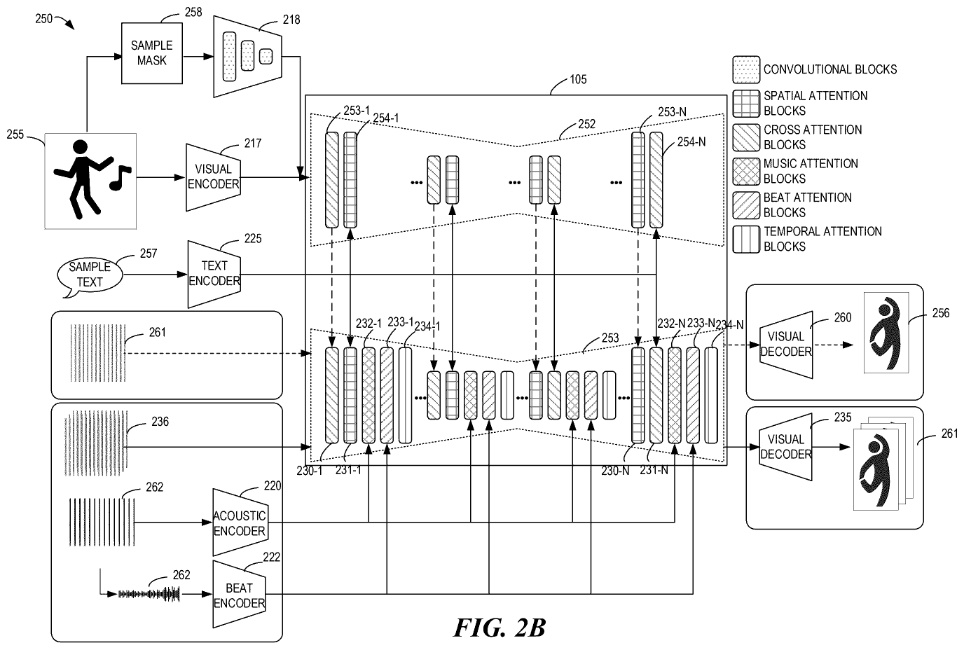

FIG. 3 illustrates a flowchart of a process 300 for video generation in accordance with some embodiments of the present disclosure. The process 300 may be implemented at the electronic device 110 of FIG. 1.

At block 310, the electronic device 110 obtains a reference image comprising an object, a music audio, and a text prompt describing a motion to be performed by the object.

At block 320, the electronic device 110 determines beat information based on the music audio.

At block 330, the electronic device 110 generates, using a trained video generation model, a video based on the reference image, the music audio, the text prompt, and the beat information, wherein the video contains a motion sequence of the object that aligns with beats in the music audio.

In some embodiments, generating the video comprises: obtaining a plurality of masks for masking a plurality of segments in the reference image, respectively, wherein the plurality of segments comprises a background of the reference image, and a plurality of parts of the object; generating the video further based on the plurality of masks.

In some embodiments, generating the video further based on the plurality of masks comprises: extracting a first visual feature representation of the reference image, the first visual feature representation characterizing an appearance of the object; extracting a second visual feature representation of the plurality of masks, the second visual feature representation characterizing a pose of the object; combining the first visual feature representation and the second visual feature representation, to obtain a combined visual feature representation; and generating the video based on the combined visual feature representation, the music audio, the text prompt, and the beat information.

In some embodiments, generating the video comprises: extracting an acoustic feature representation of the music audio, the acoustic feature representation characterizing semantics of the music audio; extracting a beat feature representation of the beat information, the beat feature representation characterizing beats of the music audio; and generating the video based on the reference image, the acoustic feature representation, the text prompt and the beat feature representation.

In some embodiments, generating the video comprises: applying respective attention mechanisms to a combined visual feature representation of the reference image, an acoustic feature representation of the music audio, a text feature representation of the text prompt and a beat feature representation of the beat information, to obtain a video feature representation; and generating the video by decoding the video feature representation.

In some embodiments, applying the respective attention mechanisms to obtain the video feature representation comprises: applying a self-attention mechanism to the combined visual feature representation, to obtain an updated visual feature representation; applying a cross-attention mechanism to the updated visual feature representation and the text feature representation, to obtain a first fused feature representation; applying a cross-attention mechanism to the first fused feature representation and the acoustic feature representation, to obtain a second fused feature representation; applying a cross-attention mechanism to the second fused feature representation and the beat feature representation, to obtain a third fused feature representation; and applying a self-attention mechanism to the third fused feature representation, to obtain the video feature representation.

In some embodiments, the video generation model is constructed based on a diffusion model, and generating the video comprises: performing a denoising operation iteratively on a sequence of noise images based on the reference image, the music audio, the text prompt, and the beat information, to obtain a sequence of denoised images; and generating the video based on the sequence of denoised images.

In some embodiments, determining the beat information comprises: identifying a plurality of beats from a plurality of audio frames of the music audio; and determining the beat information based on the plurality of beats, the beat information indicating that a plurality of audio frames with the plurality beats in the music audio are assigned a first value and audio frames other than the plurality of audio frames are assigned a second value.

In some embodiments, the video generation model at least comprises a spatial attention block and a cross-attention block, and wherein training of the video generation model comprises training the spatial attention block and the cross-attention block by: selecting a sample reference image and a target image from a sample video comprising a sample object performing a sample motion; obtaining a sample text describing the sample motion; generating, at least using the spatial attention block and the cross-attention block, a predicted image based on the sample reference image and the sample text; and updating the spatial attention block and the cross-attention block based on a difference between the predicted image and the target image.

In some embodiments, the video generation model further comprises a music attention block, a beat attention block and a temporal attention block, and wherein the training of the video generation model further comprises training by: generating, using the video generation model, a predicted video based on a first image of the sample video, the sample text, and a sample music audio corresponding to the sample video; and updating the music attention block, the beat attention block and the temporal attention block based on a difference between the predicted video and the sample video, while maintaining the spatial attention block and the cross-attention block unchanged.

In some embodiments, the sample text is generated, using a language model, based on the sample video.

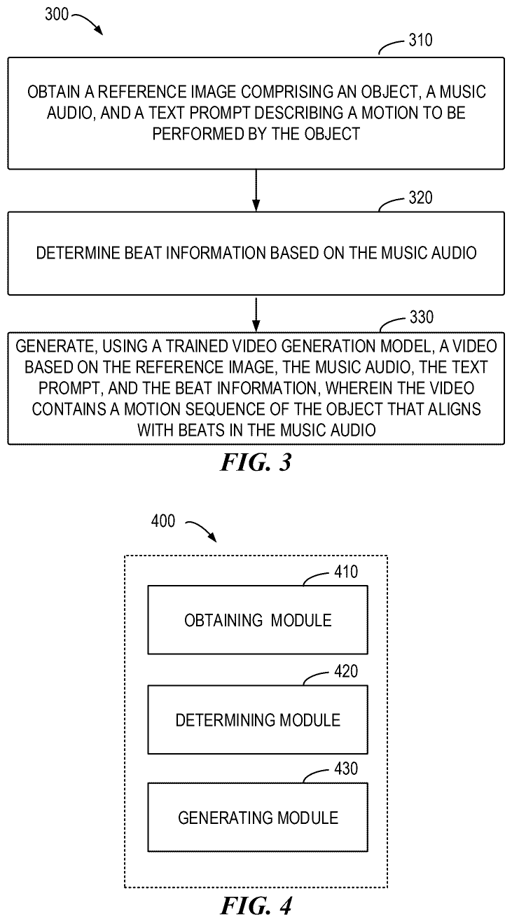

FIG. 4 shows a block diagram of an apparatus 400 for video generation in accordance with some embodiments of the present disclosure. The apparatus 400 may be implemented, for example, or included at the electronic device 110 of FIG. 1. Various modules/components in the apparatus 400 may be implemented by hardware, software, firmware, or any combination thereof.

As shown, the apparatus 400 includes an obtaining module 410 configured to obtain a reference image comprising an object, a music audio, and a text prompt describing a motion to be performed by the object; a determining module 420 configured to determine beat information based on the music audio; and a generating module 430 configured to generate, using a trained video generation model, a video based on the reference image, the music audio, the text prompt, and the beat information, wherein the video contains a motion sequence of the object that aligns with beats in the music audio.

In some embodiments, the generating module 430 is further configured to obtain a plurality of masks for masking a plurality of segments in the reference image, respectively, wherein the plurality of segments comprises a background of the reference image, and a plurality of parts of the object, and generate the video further based on the plurality of masks

In some embodiments, the generating module 430 is further configured to extract a first visual feature representation of the reference image, the first visual feature representation characterizing an appearance of the object, extract a second visual feature representation of the plurality of masks, the second visual feature representation characterizing a pose of the object, combine the first visual feature representation and the second visual feature representation, to obtain a combined visual feature representation and generate the video based on the combined visual feature representation, the music audio, the text prompt, and the beat information.

In some embodiments, the generating module 430 is further configured to extract an acoustic feature representation of the music audio, the acoustic feature representation characterizing semantics of the music audio, extract a beat feature representation of the beat information, the beat feature representation characterizing beats of the music audio and generate the video based on the reference image, the acoustic feature representation, the text prompt and the beat feature representation.

In some embodiments, the generating module 430 is further configured to apply respective attention mechanisms to a combined visual feature representation of the reference image, an acoustic feature representation of the music audio, a text feature representation of the text prompt and a beat feature representation of the beat information, to obtain a video feature representation and generate the video by decoding the video feature representation.

In some embodiments, the generating module 430 is further configured to apply a self-attention mechanism to the combined visual feature representation, to obtain an updated visual feature representation, apply a cross-attention mechanism to the updated visual feature representation and the text feature representation, to obtain a first fused feature representation, apply a cross-attention mechanism to the first fused feature representation and the acoustic feature representation, to obtain a second fused feature representation, apply a cross-attention mechanism to the second fused feature representation and the beat feature representation, to obtain a third fused feature representation and apply a self-attention mechanism to the third fused feature representation, to obtain the video feature representation.

In some embodiments, the video generation model is constructed based on a diffusion model. The generating module 430 is further configured to perform a denoising operation iteratively on a sequence of noise images based on the reference image, the music audio, the text prompt, and the beat information, to obtain a sequence of denoised images and generate the video based on the sequence of denoised images.

In some embodiments, the determining module 420 is further configured to identify a plurality of beats from a plurality of audio frames of the music audio and determine the beat information based on the plurality of beats, the beat information indicating that a plurality of audio frames with the plurality beats in the music audio are assigned a first value and audio frames other than the plurality of audio frames are assigned a second value.

In some embodiments, the video generation model at least comprises a spatial attention block and a cross-attention block. The apparatus further comprises a model training module configured to select a sample reference image and a target image from a sample video comprising a sample object performing a sample motion, obtain a sample text describing the sample motion, generate, at least using the spatial attention block and the cross-attention block, a predicted image based on the sample reference image and the sample text and update the spatial attention block and the cross-attention block based on a difference between the predicted image and the target image.

In some embodiments, the video generation model further comprises a music attention block, a beat attention block and a temporal attention block. The model training module is configured to generate, using the video generation model, a predicted video based on a first image of the sample video, the sample text, and a sample music audio corresponding to the sample video and update the music attention block, the beat attention block and the temporal attention block based on a difference between the predicted video and the sample video, while maintaining the spatial attention block and the cross-attention block unchanged.

In some embodiments, the sample text is generated, using a language model, based on the sample video.

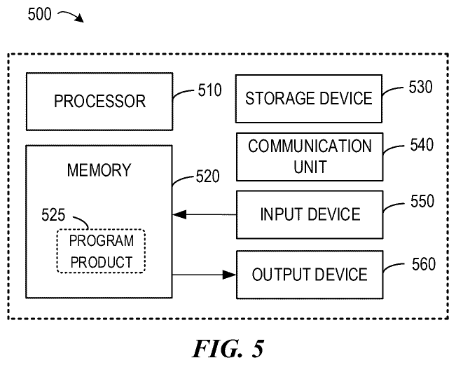

FIG. 5 illustrates a block diagram of an electronic device 500 in which one or more embodiments of the present disclosure can be implemented. It would be appreciated that the electronic device 500 shown in FIG. 5 is only an example and should not constitute any restriction on the function and scope of the embodiments described herein. The electronic device 500 may be used, for example, to implement the electronic device 110 of FIG. 1. The electronic device 500 may also be used to implement the apparatus 400 of FIG. 4.

As shown in FIG. 5, the electronic device 500 is in the form of a general computing device. The components of the electronic device 500 may include, but are not limited to, one or more processing units or processors 510, a memory 520, a storage device 530, one or more communication units 540, one or more input devices 550, and one or more output devices 560. The processor 510 may be an actual or virtual processor and can execute various processes according to the programs stored in the memory 520. In a multiprocessor system, multiple processing units execute computer executable instructions in parallel to improve the parallel processing capability of the electronic device 500.

The electronic device 500 typically includes a variety of computer storage medium. Such medium may be any available medium that is accessible to the electronic device 500, including but not limited to volatile and non-volatile medium, removable and non-removable medium. The memory 520 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 530 may be any removable or non-removable medium, and may include a machine-readable medium, such as a flash drive, a disk, or any other medium, which can be used to store information and/or data (such as training data for training) and can be accessed within the electronic device 600.

The electronic device 500 may further include additional removable/non-removable, volatile/non-volatile, transitory/non-transitory storage medium. Although not shown in FIG. 5, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 520 may include a computer program product 525, which has one or more program modules configured to perform various methods or acts of various embodiments of the present disclosure.

The communication unit 540 communicates with a further computing device through the communication medium. In addition, functions of components in the electronic device 500 may be implemented by a single computing cluster or multiple computing machines, which can communicate through a communication connection. Therefore, the electronic device 500 may be operated in a networking environment using a logical connection with one or more other servers, a network personal computer (PC), or another network node.

The input device 550 may be one or more input devices, such as a mouse, a keyboard, a trackball, etc. The output device 560 may be one or more output devices, such as a display, a speaker, a printer, etc. The electronic device 500 may also communicate with one or more external devices (not shown) through the communication unit 540 as required. The external device, such as a storage device, a display device, etc., communicate with one or more devices that enable users to interact with the electronic device 500, or communicate with any device (for example, a network card, a modem, etc.) that makes the electronic device 500 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method of video generation, comprising:
obtaining a reference image comprising an object, a music audio, and a text prompt describing a motion to be performed by the object;
determining beat information based on the music audio; and
generating, using a trained video generation model, a video based on the reference image, the music audio, the text prompt, and the beat information, wherein the video contains a motion sequence of the object that aligns with beats in the music audio.

2. The method of claim 1, wherein generating the video comprises:
obtaining a plurality of masks for masking a plurality of segments in the reference image, respectively, wherein the plurality of segments comprises a background of the reference image, and a plurality of parts of the object;
generating the video further based on the plurality of masks.

3. The method of claim 2, wherein generating the video further based on the plurality of masks comprises:
extracting a first visual feature representation of the reference image, the first visual feature representation characterizing an appearance of the object;
extracting a second visual feature representation of the plurality of masks, the second visual feature representation characterizing a pose of the object;
combining the first visual feature representation and the second visual feature representation, to obtain a combined visual feature representation; and
generating the video based on the combined visual feature representation, the music audio, the text prompt, and the beat information.

4. The method of claim 1, wherein generating the video comprises:
extracting an acoustic feature representation of the music audio, the acoustic feature representation characterizing semantics of the music audio;
extracting a beat feature representation of the beat information, the beat feature representation characterizing beats of the music audio; and
generating the video based on the reference image, the acoustic feature representation, the text prompt and the beat feature representation.

5. The method of claim 1, wherein generating the video comprises:
applying respective attention mechanisms to a combined visual feature representation of the reference image, an acoustic feature representation of the music audio, a text feature representation of the text prompt and a beat feature representation of the beat information, to obtain a video feature representation; and
generating the video by decoding the video feature representation.

6. The method of claim 5, wherein applying the respective attention mechanisms to obtain the video feature representation comprises:
applying a self-attention mechanism to the combined visual feature representation, to obtain an updated visual feature representation;
applying a cross-attention mechanism to the updated visual feature representation and the text feature representation, to obtain a first fused feature representation;
applying a cross-attention mechanism to the first fused feature representation and the acoustic feature representation, to obtain a second fused feature representation;
applying a cross-attention mechanism to the second fused feature representation and the beat feature representation, to obtain a third fused feature representation; and
applying a self-attention mechanism to the third fused feature representation, to obtain the video feature representation.

7. The method of claim 1, wherein the video generation model is constructed based on a diffusion model, and generating the video comprises:
performing a denoising operation iteratively on a sequence of noise images based on the reference image, the music audio, the text prompt, and the beat information, to obtain a sequence of denoised images; and
generating the video based on the sequence of denoised images.

8. The method of claim 1, wherein determining the beat information comprises:
identifying a plurality of beats from a plurality of audio frames of the music audio; and
determining the beat information based on the plurality of beats, the beat information indicating that a plurality of audio frames with the plurality beats in the music audio are assigned a first value and audio frames other than the plurality of audio frames are assigned a second value.

9. The method of claim 1, wherein the video generation model at least comprises a spatial attention block and a cross-attention block, and wherein training of the video generation model comprises training the spatial attention block and the cross-attention block by:
selecting a sample reference image and a target image from a sample video comprising a sample object performing a sample motion;
obtaining a sample text describing the sample motion;
generating, at least using the spatial attention block and the cross-attention block, a predicted image based on the sample reference image and the sample text; and
updating the spatial attention block and the cross-attention block based on a difference between the predicted image and the target image.

10. The method of claim 9, wherein the video generation model further comprises a music attention block, a beat attention block and a temporal attention block, and wherein the training of the video generation model further comprises training by:
generating, using the video generation model, a predicted video based on a first image of the sample video, the sample text, and a sample music audio corresponding to the sample video; and
updating the music attention block, the beat attention block and the temporal attention block based on a difference between the predicted video and the sample video, while maintaining the spatial attention block and the cross-attention block unchanged.

11. The method of claim 9, wherein the sample text is generated, using a language model, based on the sample video.

12. An electronic device, comprising:
at least one processor; and
at least one memory coupled to the at least one processor and storing instructions executable by the at least one processor, the instructions, upon execution by the at least one processor, causing the electronic device to perform operations comprising:
obtaining a reference image comprising an object, a music audio, and a text prompt describing a motion to be performed by the object;
determining beat information based on the music audio; and
generating, using a trained video generation model, a video based on the reference image, the music audio, the text prompt, and the beat information, wherein the video contains a motion sequence of the object that aligns with beats in the music audio.

13. The electronic device of claim 12, wherein generating the video comprises:
obtaining a plurality of masks for masking a plurality of segments in the reference image, respectively, wherein the plurality of segments comprises a background of the reference image, and a plurality of parts of the object;
generating the video further based on the plurality of masks.

14. The electronic device of claim 13, wherein generating the video further based on the plurality of masks comprises:
extracting a first visual feature representation of the reference image, the first visual feature representation characterizing an appearance of the object;
extracting a second visual feature representation of the plurality of masks, the second visual feature representation characterizing a pose of the object;
combining the first visual feature representation and the second visual feature representation, to obtain a combined visual feature representation; and
generating the video based on the combined visual feature representation, the music audio, the text prompt, and the beat information.

15. The electronic device of claim 12, wherein generating the video comprises:
extracting an acoustic feature representation of the music audio, the acoustic feature representation characterizing semantics of the music audio;
extracting a beat feature representation of the beat information, the beat feature representation characterizing beats of the music audio; and
generating the video based on the reference image, the acoustic feature representation, the text prompt and the beat feature representation.

16. The electronic device of claim 12, wherein generating the video comprises:
applying respective attention mechanisms to a combined visual feature representation of the reference image, an acoustic feature representation of the music audio, a text feature representation of the text prompt and a beat feature representation of the beat information, to obtain a video feature representation; and
generating the video by decoding the video feature representation.

17. The electronic device of claim 16, wherein applying the respective attention mechanisms to obtain the video feature representation comprises:
applying a self-attention mechanism to the combined visual feature representation, to obtain an updated visual feature representation;
applying a cross-attention mechanism to the updated visual feature representation and the text feature representation, to obtain a first fused feature representation;
applying a cross-attention mechanism to the first fused feature representation and the acoustic feature representation, to obtain a second fused feature representation;
applying a cross-attention mechanism to the second fused feature representation and the beat feature representation, to obtain a third fused feature representation; and
applying a self-attention mechanism to the third fused feature representation, to obtain the video feature representation.

18. The electronic device of claim 12, wherein the video generation model is constructed based on a diffusion model, and generating the video comprises:
performing a denoising operation iteratively on a sequence of noise images based on the reference image, the music audio, the text prompt, and the beat information, to obtain a sequence of denoised images; and
generating the video based on the sequence of denoised images.

19. The electronic device of claim 12, wherein determining the beat information comprises:
identifying a plurality of beats from a plurality of audio frames of the music audio; and
determining the beat information based on the plurality of beats, the beat information indicating that a plurality of audio frames with the plurality beats in the music audio are assigned a first value and audio frames other than the plurality of audio frames are assigned a second value.

20. A non-transitory computer readable storage medium having computer executable instructions stored thereon, the computer executable instructions, when executed by an electronic device, causing the electronic device to perform operations comprising:
obtaining a reference image comprising an object, a music audio, and a text prompt describing a motion to be performed by the object;
determining beat information based on the music audio; and
generating, using a trained video generation model, a video based on the reference image, the music audio, the text prompt, and the beat information, wherein the video contains a motion sequence of the object that aligns with beats in the music audio.
